(19) United States
(12) Patent Application Publication
(10) Pub. No.: US 2009/0082355 A1
(43) Pub. Date: Mar. 26, 2009

(54) Method of Combating Root Weevils

(75) Inventors: Wolfgang von Deyn, Neustadt (DE); Samuel Wells, Cary, NC (US); Hassan Oloumi-Sadeghi, Raleigh, NC (US); Nigel Armes, Raleigh, NC (US); David G. Kuhn, Apex, NC (US)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/159,508

(22) PCT Filed: Dec. 21, 2006
(86) PCT No.: PCT/EP2006/070073

§ 371 Date: Jun. 27, 2008

Related U.S. Application Data
(60) Provisional application No. 60/756,050, filed on Jan. 4, 2006.

(51) Int. Cl. A01N 43/66; A01N 37/18; A01P 7/04

(52) U.S. Cl. 514/245; 514/614

(57) ABSTRACT

A method of combating root weevils comprising contacting the root weevils or their food supply, habitat, breeding grounds or their locus with a pesticidally effective amount of a compound of the formula (I) wherein W is Cl or CF₃; X and Y are each independently Cl or Br; R¹ is alkyl, alkenyl, alkynyl, or cycloalkyl optionally substituted with 1 to 3 halogens, or alkyl which is substituted by alkoxy; R² and R³ are alkyl or may be taken together to form cycloalkyl optionally substituted by 1 to 3 halogens; R⁴ is H or C₁-C₆-alkyl, or the enantiomers or salts thereof.

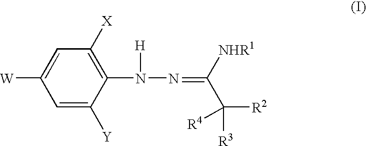

The present invention relates to a method of combating root weevils comprising contacting the root weevils or their food supply, habitat, breeding grounds or their locus with a pesticidally effective amount of a compound of formula I

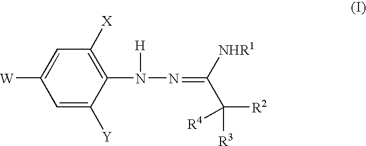

wherein
W is chlorine or trifluoromethyl;
X and Y are each independently chlorine or bromine;
R¹ is C₁-C₆-alkyl, C₃-C₆-alkenyl, C₃-C₆-alkynyl, or
   C₃-C₆-cycloalkyl which may be substituted with 1 to 3 halogen atoms, or
   C₂-C₄-alkyl which is substituted by C₁-C₄-alkoxy;
R² and R³ are C₁-C₆-alkyl or may be taken together to form C₃-C₆-cycloalkyl which may be unsubstituted or substituted by 1 to 3 halogen atoms;
R⁴ is hydrogen or C₁-C₆-alkyl,
   or the enantiomers or salts thereof.

The present invention also relates to the use of compounds of formula I and of compositions comprising them for combating root weevils.

The black vine weevil (Otiorhynchus sulcatus) and several related species, such as the clay-coloured weevil (Otiorhynchus singularis) and the strawberry-root weevils (Otiorhynchus ovatus and Otiorhynchus rugifrons), but also weevils of the Diaprepres species can cause severe damage to house and garden plants, but are also troublesome in the nursery industry and in fruit plantations. All of these weevils are collectively called root weevils because their larvae feed on a variety of plant roots.

For example, adult black vine weevils feed on over 100 different kinds of plants including trees, shrubs, vines and flowers. The preferred host plants seem to be Taxus (yews), hemlock and various rhododendrons. The clay-coloured weevil is particularly associated with damage to apples, currants, gooseberries, raspberries, roses, rhododendrons, polyanthus and clematis, whereas the strawberry-root weevils are mainly pests of strawberries.

Adult weevils feed on the margins of foliage, giving the plant a rather ragged appearance. Generally injury begins close to the ground and towards the inside of the plant. Weevil larvae feed both on fine roots and also at the base of the stem. Infested plants grow slowly or fail to grow. Infected, newly planted stock dies without becoming established.

Damage from e.g. black vine weevils (and other root weevils) can be reduced by the use of pesticides, e.g. organophosphates, such as acephate and chloropyrifos, or pyrethroids, such as permethrin or cyhalothrin. Because of their nocturnal behavior and subterranean habits, black vine weevils can be difficult to control. After adults emerge, spring applications of insecticides are recommended in order to control adults before eggs are laid. However, due to the prolonged period of adult activity, several spray applications may be needed.

Thus, there is still need of alternative methods for controlling root weevils.

It was therefore an object of the present invention to provide a new method for combating root weevils.

We have found that this object is achieved by the present invention.

The insecticidal and acaricidal activity in plant protection in the agricultural field of some of the compounds of formula I has been described in EP-A 604 798, and also in J. A Furch et al., “Amidrazones: A New Class of Coleopteran Insecticides”, ACS Symposium Series 686, Am. Chem. Soc., 1998, Chapter 18, pp. 178-184, and also in D. G. Kuhn et al., “Cycloalkyl-substituted Amidrazones: A Novel Class of Insect Control Agents”, ACS Symposium Series 686, Am. Chem. Soc., 1998, Chapter 19, pp. 185-193. No mention is made in these documents of the use of compounds I against root weevils.

Preferably, the present invention is useful for combating root weevils of the Otiorhynchus species.

The inventive method is especially useful for combating root weevils of the following Otiorhynchus species: Otiorhynchus sulcatus (black vine weevil), Otiorhynchus rugosotriatus (rough strawberry root weevil), Otiorhynchus ovatus, Otiorhynchus rugifrons (both strawberry root weevils), Otiorhynchus singularis (clay-coloured weevil), with Otiorhynchus sulcatus (black vine weevil) being the most preferred.

The inventive method is especially useful for control of root weevils in house and garden plants, preferably ornamental perennials such as Taxus (yew), Tsuga (hemlock), Thuja (cedar), Pinus (pine), Picea (spruce), Euonymus, Rhododendron, Abies (fir), Azalea, Buxus, Cupressus, Forsythia, Fragaria, Hosta, and Hydrangea.

The inventive method is especially useful for control of root weevils in fruit crops, preferably apples, currants, gooseberries, raspberries, strawberries, grapes, blackberries, and stone fruit.

Very preferably, the inventive method is used against the black vine weevil in potted ornamentals such as yew, azalea, and rododendron.

With respect to their intended use according to the present invention, preference is further given to compounds of formula I wherein

W is trifluoromethyl;
X and Y are each independently chlorine or bromine;
R¹ is C₁-C₆-alkyl;
R² and R³ are C₁-C₆-alkyl or may be taken together to form C₃-C₆-cycloalkyl which is substituted by 1 to 2 halogen atoms;
R⁴ is C₁-C₆-alkyl;
or the enantiomers or salts thereof.

Particular preference is given to N-ethyl-2,2-dimethylpropionamide-2-(2,6-dichloro-α,α,α-trifluoro-p-tolyl)hydrazone and N-Ethyl-2,2-dichloro-1-methylcyclopropane-carboxamide, 2-(2,6-dichloro-α,α,α-trifluoro-p-tolyl)hydrazone.

Particular preference is given to N-ethyl-2,2-dimethylpropionamide-2-(2,6-dichloro-α,α,α-trifluoro-p-tolyl)hydrazone.

Also, particular preference is given to N-Ethyl-2,2-dichloro-1-methylcyclopropane-carboxamide, 2-(2,6-dichloro-α,α,α-trifluoro-p-tolyl)hydrazone.

For their use according the present invention, the compounds I can be converted into customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8), for example by extending the active compound with auxiliaries suitable for the formulation of agrochemicals, such as solvents and/or carriers, if desired emulsifiers, surfactants and dispersants, preservatives, antifoaming agents, and anti-freezing agents.

Examples of suitable solvents are water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.

Suitable emulsifiers are nonionic and anionic emulsifiers (for example polyoxyethylene fatty alcohol ethers, alkylsulfonates and arylsulfonates).

Examples of dispersants are lignin-sulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Also anti-freezing agents such as glycerin, ethylene glycol, propylene glycol and bactericides such as can be added to the formulation.

Suitable antifoaming agents are for example antifoaming agents based on silicon or magnesium stearate.

Suitable preservatives are for example Dichlorophen und enzylalkoholhemiformal.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers.

Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compound(s). In this case, the active compound(s) are employed in a purity of from 90% to 100% by weight, preferably 95% to 100% by weight (according to NMR spectrum).

The compounds of formula I or mixtures comprising them can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compound(s) according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier.

However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1% per weight.

The active compound(s) may also be used successfully in the ultra-low-volume process (ULV), it being possible to apply formulations comprising over 95% by weight of active compound, or even to apply the active compound without additives.

The following are examples of formulations: 1. Products for dilution with water for foliar applications.

### A) Water-Soluble Concentrates (SL)

10 parts by weight of the active compound(s) are dissolved in 90 parts by weight of water or a water-soluble solvent. As an alternative, wetters or other auxiliaries are added. The active compound(s) dissolves upon dilution with water, whereby a formulation with 10% (w/w) of active compound(s) is obtained.

### B) Dispersible Concentrates (DC)

20 parts by weight of the active compound(s) are dissolved in 70 parts by weight of cyclohexanone with addition of 10 parts by weight of a dispersant, for example polyvinylpyrrolidone. Dilution with water gives a dispersion, whereby a formulation with 20% (w/w) of active compound(s) is obtained.

### C) Emulsifiable Concentrates (EC)

15 parts by weight of the active compound(s) are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of active compound(s) is obtained.

### D) Emulsions (EW, EO)

25 parts by weight of the active compound(s) are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of active compound(s) is obtained.

### E) Suspensions (SC, OD)

In an agitated ball mill, 20 parts by weight of the active compound(s) are comminuted with addition of 10 parts by weight of dispersants, wetters and 70 parts by weight of water or of an organic solvent to give a fine active compound(s) suspension. Dilution with water gives a stable suspension of the active compound(s), whereby a formulation with 20% (w/w) of active compound(s) is obtained.

### F) Water-Dispersible Granules and Water-Soluble Granules (WG)

50 parts by weight of the active compound(s) are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of active compound(s) is obtained.

### G) Water-Dispersible Powders and Water-Soluble Powders (WP, SP)

75 parts by weight of the active compound(s) are ground in a rotor-stator mill with addition of 25 parts by weight of dispersants, wetters and silica gel. Dilution with water gives a stable dispersion or solution of the active compound(s), whereby a formulation with 75% (w/w) of active compound(s) is obtained.

### 2. Products to be Applied Undiluted for Foliar Applications.

### I) Dustable Powders (DP)

5 parts by weight of the active compound(s) are ground finely and mixed intimately with 95 parts by weight of finely divided kaolin. This gives a dustable product having 5% (w/w) of active compound(s).

### J) Granules (GR, FG, GG, MG)

0.5 part by weight of the active compound(s) is ground finely and associated with 95.5 parts by weight of carriers, whereby a formulation with 0.5% (w/w) of active compound(s) is obtained. Current methods are extrusion, spray-drying or the fluidized bed. This gives granules to be applied undiluted for foliar use.

### K) ULV Solutions (UL)

10 parts by weight of the active compound(s) are dissolved in 90 parts by weight of an organic solvent, for example xylene. This gives a product having 10% (w/w) of active compound(s), which is applied undiluted for foliar use.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Compositions of this invention may also contain other active ingredients, for example other oils, wetters, adjuvants, herbicides, fungicides, insecticides, fertilizers such as ammonium nitrate, urea, potash, and superphosphate, phytotoxicants and plant growth regulators, safeners and nematicides. These additional ingredients may be used sequentially or in combination with the above-described compositions, if appropriate also added only immediately prior to use (tank mix). For example, the plant(s) may be sprayed with a composition of this invention either before or after being treated with other active ingredients. These agents can be admixed with the agents according to the invention in a weight ratio of 1:10 to 10:1.

The following list of pesticides together with which the compounds of formula I can be used according to the inventive method, is intended to illustrate the possible combinations, but not to impose any limitation:

A.1. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
A.2. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
A.3. Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin;
A.4. Growth regulators: a) chitin synthesis inhibitors: benzoylureas: chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
A.5. Nicotinic receptor agonists/antagonists compounds: clothianidin, dinotefuran, imidacloprid, thiamethoxam, nitenpyram, acetamiprid, thiacloprid; the thiazol compound of formula Γ¹

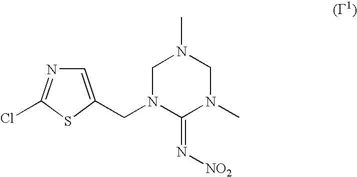

A.6. GABA antagonist compounds: acetoprole, endosulfan, ethiprole, fipronil, vaniliprole, pyrafluprole, pyriprole, the phenylpyrazole compound of formula Γ²

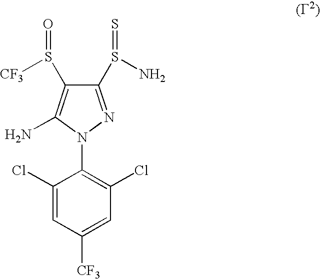

A.7. Macrocyclic lactone insecticides: abamectin, emamectin, milbemectin, lepimectin, spinosad;
A.8. METI I compounds: fenazaquin, pyridaben, tebufenpyrad, tolfenpyrad, flufenerim;
A.9. METI II and III compounds: acequinocyl, fluacyprim, hydramethylnon;
A.10. Uncoupler compounds: chlorfenapyr;
A.11. Oxidative phosphorylation inhibitor compounds: cyhexatin, diafenthiuron, fenbutatin oxide, propargite;
A.12. Moulting disruptor compounds: cyromazine;
A.13. Mixed Function Oxidase inhibitor compounds: piperonyl butoxide;
A.14. Sodium channel blocker compounds: indoxacarb, metaflumizone,
A.15. Various: benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoisothiazole compounds of formula Γ³,

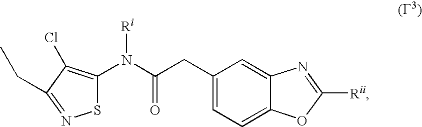

wherein Rⁱ is —CH₂OCH₂CH₃ or H and Rⁱⁱ is CF₂CF₂CF₃ or CH₂CH(CH₃)₃, the anthranilamide compounds of formula Γ⁴

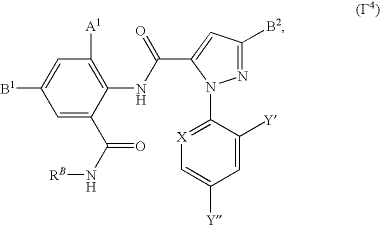

wherein A¹ is CH₃, Cl, Br, I, X is C—H, C—Cl, C—F or N, Y′ is F, Cl, or Br, Y″ is hydrogen, F, Cl, CF₃, B¹ is hydrogen, Cl, Br, I, CN, B² is Cl, Br, CF₃, OCH₂CF₃, OCF₂H, and R^{B} is hydrogen, CH₃ or CH(CH₃)₂, and the malononitrile compounds as described in JP 2002 284608, WO 02/89579, WO 02/90320, WO 02/90321, WO 04/06677, WO 04/20399, JP 2004 99597, WO 05/68423, WO 05/68432, or WO 05/63694, especially the malononitrile compounds CF₂HCF₂CF₂CF₂CH₂C(CN)₂CH₂CH₂CF₃ (2-(2,2,3,3,4,4,5,5-octafluoropentyl)-2-(3,3,3-trifluoropropyl)malononitrile), CF₃(CH₂)₂C(CN)₂CH₂(CF₂)₅CF₂H (2-(2,2,3,3,4,4,5,5,6,6,7,7-Dodecafluoro-heptyl)-2-(3,3,3-trifluoro-propyl)-malononitrile), CF₃(CH₂)₂C(CN)₂(CH₂)₂C(CF₃)₂F (2-(3,4,4,4-Tetrafluoro-3-trifluoromethyl-butyl)-2-(3,3,3-trifluoro-propyl)-malononitrile), CF₃(CH₂)₂C(CN)₂(CH₂)₂(CF₂)₃CF₃ (2-(3,3,4,4,5,5,6,6,6-Nonafluoro-hexyl)-2-(3,3,3-trifluoro-propyl)-malononitrile), CF₂H(CF₂)₃CH₂C(CN)₂CH₂(CF₂)₃CF₂H (2,2-Bis-(2,2,3,3,4,4,5,5-octafluoro-pentyl)-malononitrile), CF₃(CH₂)₂C(CN)₂CH₂(CF₂)₃CF₃ (2-(2,2,3,3,4,4,5,5,5-Nonafluoro-pentyl)-2-(3,3,3-trifluoro-propyl)-malononitrile), CF₃(CF₂)₂CH₂C(CN)₂CH₂(CF₂)₃CF₂H (2-(2,2,3,3,4,4,4-Heptafluoro-butyl)-2-(2,2,3,3,4,4,5,5-octafluoro-pentyl)-malononitrile) and CF₃CF₂CH₂C(CN)₂CH₂(CF₂)₃CF₂H (2-(2,2,3,3,4,4,5,5-Octafluoro-pentyl)-2-(2,2,3,3,3-pentafluoro-propyl)-malononitrile).

The commercially available compounds of the group A may be found in The Pesticide Manual, 13^{th} Edition, British Crop Protection Council (2003) among other publications. Thioamides of formula Γ² and their preparation have been described in WO 98/28279. Aminoisothiazole compounds of formula Γ³ and their preparation have been described in WO 00/06566. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54,1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. Cyflumetofen and its preparation have been described in WO 04/080180. Anthranilamides of formula Γ⁴ and their preparation have been described in WO 01/70671; WO 02/48137; WO 03/24222, WO 03/15518, WO 04/67528; WO 04/33468; and WO 05/118552. The malononitrile compounds CF₂HCF₂CF₂CF₂CH₂C(CN)₂CH₂CH₂CF₃ (2-(2,2,3,3,4,4,5,5-octafluoropentyl)-2-(3,3,3-trifluoropropyl)malononitrile), CF₃(CH₂)₂C(CN)₂CH₂(CF₂)₅CF₂H (2-(2,2,3,3,4,4,5,5,6,6,7,7-Dodecafluoro-heptyl)-2-(3,3,3-trifluoro-propyl)-malononitrile), CF₃(CH₂)₂C(CN)₂(CH₂)₂C(CF₃)₂F (2-(3,4,4,4-Tetrafluoro-3-trifluoromethyl-butyl)-2-(3,3,3-trifluoro-propyl)-malononitrile), CF₃(CH₂)₂C(CN)₂(CH₂)₂(CF₂)₃CF₃ (2-(3,3,4,4,5,5,6,6,6-Nonafluoro-hexyl)-2-(3,3,3-trifluoro-propyl)-malononitrile), CF₂H(CF₂)₃CH₂C(CN)₂CH₂(CF₂)₃CF₂H (2,2-Bis-(2,2,3,3,4,4,5,5-octafluoro-pentyl)-malononitrile), CF₃(CH₂)₂C(CN)₂CH₂(CF₂)₃CF₃ (2-(2,2,3,3,4,4,5,5,5-Nonafluoro-pentyl)-2-(3,3,3-trifluoro-propyl)-malononitrile), CF₃(CF₂)₂CH₂C(CN)₂CH₂(CF₂)₃CF₂H (2-(2,2,3,3,4,4,4-Heptafluoro-butyl)-2-(2,2,3,3,4,4,5,5-octafluoro-pentyl)-malononitrile) and CF₃CF₂CH₂C(CN)₂CH₂(CF₂)₃CF₂H (2-(2,2,3,3,4,4,5,5-Octafluoro-pentyl)-2-(2,2,3,3,3-pentafluoro-propyl)-malononitrile) have been described in WO 05/63694.

The root weevils may be controlled by contacting the root weevil, its food supply, habitat, breeding ground or its locus with a pesticidally effective amount of compounds of or compositions of formula I.

“Locus” means a habitat, breeding ground, plant, seed, soil, area, material or environment in which a root weevil is growing or may grow.

The root weevils may also be controlled by contacting the plant—typically to the foliage, stem or roots of the plant—with a pesticidally effective amount of compounds of formula I.

In general, “pesticidally effective amount” means the amount of active ingredient needed to achieve an observable effect on growth, including the effects of necrosis, death, retardation, prevention, and removal, destruction, or otherwise diminishing the occurrence and activity of the root weevil. The pesticidally effective amount can vary for the various compounds/compositions used in the invention. A pesticidally effective amount of the compositions will also vary according to the prevailing conditions such as desired pesticidal effect and duration, weather, target species, locus, mode of application, and the like.

The compounds of formula I are effective against root weevils through both contact (via soil or plant parts), and ingestion (plant part).

For use in treating plants/fruit crops, the rate of application of the compounds of formula I may be in the range of 0.1 g to 4000 g per hectare, desirably from 25 g to 600 g per hectare, more desirably from 50 g to 500 g per hectare, and most desirably from 150 to 300 g per hectare.

In the case of soil treatment, the quantity of active ingredient ranges from 0.0001 to 500 g per 100 m², preferably from 0.001 to 20 g per 100 m².

The active ingredient can be applied as a liquid or solid formulation. The application in form of granules is preferred.

### EXAMPLES

Tests were carried out in order to evaluate the efficacy of N-Ethyl-2,2-dichloro-1-methylcyclopropane-carboxamide-2-(2,6-dichloro-α,α,α-trifluoro-p-tolyl)hydrazone (hereinafter referred to as “compound I-1”) to control the black vine weevil (Otiorhynchus sulcatus) on different ornamental plants.

1. Control of Otiorhynchus sulcatus Eggs/First Instar Larvae on the Spreading Yew (Taxus Media Densiformis)

Taxus media densiformis plants were planted in potting medium (60% parts pine bark, 20% hardwood bark and 20% peat) which had been treated before with a DC formulation of the active ingredient diluted with water. Plants were maintained outdoors under standard nursery management conditions throughout the growing season. Incubated vine weevil eggs were obtained from a culture of field-collected adults. Plants were infested with 25 brown eggs each. The total number of live larvae was recorded after 3 months. Each experiment was replicated 5 times.

In these tests, compound I-1 exhibited over 95% control at the following rates (see Table 1 below):

TABLE 1
Results of the control of the black
vine weevil on the Spreading Yew

| | Root weevil | Root weevil | Rate |
|---|---|---|---|
| Host Plant | [latin name] | [English name] | [ppm] |
| Spreading Yew | Otiorhyncus | Black vine weevil | 250 |
| (Taxus media densiformis) | sulcatus | | |
| Spreading Yew | Otiorhyncus | Black vine weevil | 750 |
| (Taxus media densiformis) | sulcatus | | |
| Spreading Yew | Otiorhyncus | Black vine weevil | 1500 |
| (Taxus media densiformis) | sulcatus | | |

2. Control of Otiorhynchus sulcatus Larvae in the Woody Ornamental Thuja occidentalis ‘Holmstrub’

Root cuttings of Thuja occidentalis ‘Holmstrub’ were potted in 3-liter containers using a standard soil substrate and first placed on an outdoor container field for four months and then transferred to an indoor container field at a temperature of 15-20° C. for another four months. In treatment method A, 750 g Suscon (chloropyrifos)/m³ were mixed through the soil substrate. In treatment method B, the calculated amount of product was dissolved in 0.75 l water and added to the 3 litre pot as a drench. The soil of the pot was moistened before application. Eggs of Otiorhynchus sulcatus (20 eggs per pot) were added to the pots 15 weeks after treatment. Approximately 8 months after treatment, the average total number of live larvae (hereinafter also referred to as “average of total larvae”) and the average feeding on the roots were determined. The feeding on the roots was assessed according to the following index rating:

1 no feeding observed
2 slight feeding
3 significant feeding, few root tips are present
4 most roots are damaged

Each experiment was replicated 4 times. The results are given in Table 2.

TABLE 2
Effect of the treatments on the average
of total larvae and feeding of root

| | | | | Average | |
|---|---|---|---|---|---|
| | | g or ml | | number of | Average |
| | | product/ | Treatment | total | feeding on |
| Object | Product | 3 l pot | method | larvae | roots |
| 1 | Untreated | — | — | 10.8 | 1.8 |
| 2 | Suscon | 2.25 | A | 2.5 | 1.2 |
| | (chloropyrifos) | | | | |
| 3 | Compound I-1 | 0.9125 | B | 0.1 | 1.1 |
| 4 | Compound I-1 | 1.825 | B | 0.0 | 1.0 |
| 5 | Compound I-1 | 3.65 | B | 0.0 | 1.0 |

The average number of total larvae and the average feeding on roots were both higher with the untreated than the other treatments. It can be seen that all treatments with compound I-1 in different doses were effective against the larvae of Otiorhynchus sulcatus. In addition, no signs of phytotoxicity were found in this trial. Compound I-1 also gave better control of Otiorhynchus sulcatus larvae and feeding damage than the standard treatment of Suscon (chloropyrifos).

3. Control of Otiorhynchus sulcatus Adults on Euonymus fortunei ‘Dart's Blanket’

The efficacy of different doses of compound I-1 to control adults of the black vine weevil (Otiorhynchus sulcatus) was tested after direct contact and after feeding of the product. The formulated product was dissolved in water and the resulting aqueous solution/suspension was applied to black vine weevil adults directly or to Euonymus fortunei branches and the branches were exposed to black vine weevil adults.

### Trial Design of Contact Effect

The treatments were applied by spraying 10 black vine weevils per petri-dish. The vine weevils were completely moistened after spraying. Afterwards the vine weevils were put into a bucket, in which 5 untreated branches of Euonymus fortunei ‘Dart's Blanket’ were placed. The buckets were randomly placed on Danish lorries in a climate cell. After 1 and 5 days, the number of dead vine weevils was counted. The climate cell was adjusted at a constant temperature of 20° C. with 16 hours of light and 8 hours of darkness. Each treatment was replicated 4 times. The results of the contact effect assessment are given in Table 3.

TABLE 3
Results of the contact effect assessment

| | | | Average number | Average number |
|---|---|---|---|---|
| Ob- | | Treatment | of dead adults | of dead adults |
| ject | Product | g a.i.*/l | after 1 day | after 5 days |
| 1 | untreated | — | 0.0 | 1.5 |
| 2 | Compound I-1 | 1.14 | 0.5 | 6.0 |
| 3 | Compound I-1 | 2.27 | 0.3 | 9.0 |
| 4 | Compound I-1 | 4.56 | 0.8 | 8.5 |

*a.i. = active ingredient

After one or five days all treatments gave a higher average number of dead vine weevils than the untreated object.

### Trial Design of Feeding Effect

4 plants of Euonymus fortunei ‘Dart's Blanket’ per treatment were sprayed until drip stadium. 10 untreated black vine weevils were put in a bucket in which 5 treated branches were placed. The buckets were randomly placed on Danish lorries in a climate cell. After 5 and 10 days the number of dead vine weevils were counted. The climate cell was adjusted at a constant temperature of 20° C. with 16 hours of light and 8 hours of darkness. Each treatment was replicated 4 times. The results of the feeding effect assessment are given in Table 4.

TABLE 4
Results of the feeding effect assessment

| | | | Average number | Average number |
|---|---|---|---|---|
| Ob- | | Treatment | of dead adults | of dead adults |
| ject | Product | g a.i.*/l | after 5 days | after 10 days |
| 1 | untreated | — | 0.0 | 2.5 |
| 2 | Compound I-1 | 1.14 | 8.5 | 10.0 |
| 3 | Compound I-1 | 2.27 | 6.5 | 8.8 |
| 4 | Compound I-1 | 4.56 | 8.8 | 10.0 |

*a.i. = active ingredient

After five or ten days all the treatments gave a significantly better control of dead vine weevils than the untreated object.

1-8. (canceled)

9. A method of combating Otiorhynchus sulcatus comprising contacting the Otiorhynchus sulcatus or their food supply, habitat, breeding grounds or their locus with a pesticidally effective amount of a compound of formula 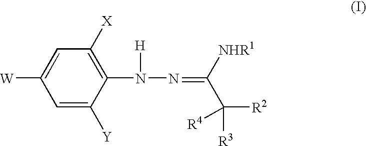
wherein
W is chlorine or trifluoromethyl;
X and Y are each independently chlorine or bromine;
R¹ is C₁-C₆-alkyl, C₃-C₆-alkenyl, C₃-C₆-alkynyl, or
C₃-C₆-cycloalkyl which may be substituted with 1 to 3 halogen atoms, or C₂-C₄-alkyl which is substituted by C₁-C₄-alkoxy;
R² and R³ are C₁-C₆-alkyl or may be taken together to form C₃-C₆-cycloalkyl which may be unsubstituted or substituted by 1 to 3 halogen atoms;
R⁴ is hydrogen or C₁-C₆-alkyl,
or the enantiomers or salts thereof.

10. A method for protecting growing plants from attack or infestation by Otiorhynchus sulcatus comprising contacting a plant, or soil or water in which the plant is growing, with a pesticidally effective amount of compositions or compounds of formula I as defined in claim 9.

11. A method according to claim 10, wherein the plant is selected from house and garden plants and fruit crops.

12. A method according to claim 11, wherein the house and garden plants are selected from the ornamental perennials Taxus, Tsuga, Thuja, Pinus, Picea, Euonymus, Rhododendron, Abies, Azalea, Buxus, Cupressus, Forsythia, Fragaria, Hosta, and Hydrangea.

13. A method according to claim 11, wherein the plants are selected from the fruit crops apples, currants, gooseberries, raspberries, strawberries, grapes, blackberries, and stone fruit.

14. A methods according to claim 9, wherein the compound of formula I as defined in claim 1 is applied in an amount of from 50 g/ha to 500 g/ha.

15. A method according to claim 9, wherein the compound of formula I as defined in claim 1 is applied in an amount of from 150 g/ha to 300 g/ha.

16. A method according to claim 9, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

17. A method according to claim 10, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

18. A method according to claim 11, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

19. A method according to claim 12, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

20. A method according to claim 13, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

21. A method according to claim 14, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.

22. A method according to claim 15, wherein the compound of formula I is N-ethyl-2,2-dimethylpropionamide-2-(2,6-dichloro-α,α,α-trifluoro-p-tolyl)hydrazone or N-ethyl-2,2-dichloro-1-methylcyclopropane-carboxamide, 2-(2,6-dichloro-α,α,α-trifluoro-p-tolyl)hydrazone.
